(19) United States
(12) Patent Application Publication
(10) Pub. No.: US 2003/0046228 A1
(43) Pub. Date: Mar. 6, 2003

(54) User-wearable functional jewelry with biometrics and smartcard to remotely sign and/or authenticate to e-services

(76) Inventor: Jean-Marc Berney, Geneva (CH)

Correspondence Address: HEWLETT-PACKARD COMPANY, Intellectual Property Administration, P.O. Box 272400, Fort Collins, CO, 80527-2400, US

(21) Appl. No.: 09/942,175

(22) Filed: Aug. 28, 2001

(51) Int. Cl. G06F 17/60

(52) U.S. Cl. 705/41

(57) ABSTRACT

A user-wearable electronic wireless transaction apparatus is disclosed. The user-wearable electronic wireless transaction apparatus comprises a housing which houses a wireless communication device, one or more electronic circuits, a power source, a display device and a biometric data reading device. While enabled as a timepiece or performing other functions suitable to a user-wearable apparatus, the apparatus can establish wireless communication with a counterpart communication apparatus in order to conduct a transaction. The biometric data reading device can read the user's applicable biometric data and then transmit a user identity validation and the wireless communication device can transmit user authorization for the transaction.

### FIELD OF THE INVENTION

The present invention relates to functional transactional devices that can be connected using wireless links. Specifically, the present invention pertains to a wireless method and system for authenticating the identity of a user to enable and authorize transactions between users and their counterparts.

### BACKGROUND OF THE INVENTION

Historically, consumer purchases were actually trades, an exchange of an item of value for a different item of similar value. The invention of currency thousands of years ago provided the ability to carry something of general value that could be exchanged for virtually any useful item, thus lightening a consumer's load considerably. The much more recent invention of credit cards has allowed the consumer to carry an item representing value that was not itself intrinsically valuable, reducing the consumer's load and value as a theft target but still allowing him or her to carry considerable purchasing power.

The still more recent invention of debit cards has enabled consumers to wield the purchasing power accorded to credit cards without meeting the credit worthiness requirements of credit accounts and without incurring the associated debt. Debit cards draw from a positive account balance maintained by the user and require verification of identification, usually a personal identification number (PIN) to complete a purchase.

“SmartCards” are another recent transaction device that also requires a personal identification number to complete a transaction. SmartCards, like debit cards, execute purchases from a positive account balance but the balance is maintained in the card itself. Additions to the card balance must be properly purchased and, typically, SmartCards have safeguards against an illicit account increase.

Credit-card and debit-card purchases require the use of a physical card or at least its entry into a purchasing system by number. In point-of-purchase transactions, the buyer must either hand the card to a salesperson or physically “swipe” the card through a card reader slot. A salesperson merely does the swiping for the buyer or enters the card number by keypad or by phone. Food purchases by use of a debit card are very common at present day supermarkets. However, virtually all consumers have horror stories of waiting in the checkout line while a customer ahead in the line fumbles ineptly through the card purchase process, unable to master the intricacies of the card reader.

Users of SmartCards are not immune to the disadvantages above. A buyer of goods from an automatic SmartCard-reading vending machine is required to swipe the card through a slot. The buyer is then required to enter a PIN to verify his or her identity and authorization for a purchase. Systems have begun to emerge that allow the non-contact use of SmartCards through RF or infrared technology. However, a PIN must still be entered at some point in the transaction. If a SmartCard is stolen and the thief is able to acquire the rightful user's PIN, then there is no safeguard remaining to prevent the thief's access to the SmartCard's entire balance.

A reliable means of determining the identity of a potential user of a SmartCard, and thus whether that person is an authorized user, is by the use of biometric data identification. Biometric data is data taken from the measurement of some characteristic peculiar to an individual. A digitized thumbprint is an example of biometric data. Iris scans, speech pattern scans or various body temperature or electrical characteristics are also biometric data.

In a system that uses biometric data for identification, a device that reads biometric data scans the relevant measurement of the candidate for identification. The attached system then compares the scanned data with data stored in the SmartCard. A match of data sets is then sufficient for identification.

A now-common implementation of such a scheme is the use of a thumbprint scanner which can read the user's thumbprint and determine whether it compares favorably with a stored thumbprint. If the user's data does not compare favorably, the system to which the identifying device is connected refuses to allow access to either on-board data or a network or, in this case, a purchase. An iris scanner or a speech pattern reader functions similarly, though may be somewhat more difficult to implement. Unfortunately, systems using biometrics still require physical contact between a user and a system and the system can be bulky and expensive.

A need exists, therefore, for a means of enabling efficient and user-friendly SmartCard transactions that does not require physical contact. A further need exists for such a means to employ biometric data reading in its operation and to fit in an easy to use and carry form factor. Another need exists for a user to be able to enable and authorize a transaction using a SmartCard without the physical exposure of a SmartCard to damaging use.

### SUMMARY OF THE INVENTION

The present invention provides a method of enabling efficient and user-friendly SmartCard transactions that does not require physical contact. Furthermore, the means employs biometric data reading in its operation and fits in an easy to use and carry form factor. Using the invention, a user can enable and authorize a transaction using a SmartCard without the physical exposure of a SmartCard to damaging use.

A user-wearable electronic wireless transaction apparatus is disclosed. The user-wearable electronic wireless transaction apparatus comprises a housing which houses a wireless communication device, one or more electronic circuits, a power source, a display device and a biometric data reading device. While enabled as a timepiece or performing other functions suitable to a user-wearable apparatus, the apparatus can establish wireless communication with a counterpart communication apparatus in order to conduct a transaction. The biometric data reading device can read the user's applicable biometric data and then transmit a user identity validation and the wireless communication device can transmit user authorization for the transaction.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The operation of this invention can be best visualized by reference to the drawings.

FIG. 1 illustrates one implementation of this embodiment of the present invention.

FIGS. 2 illustrates another implementation of this embodiment of the present invention.

FIG. 3 illustrates the execution of a wireless transaction in accordance with one embodiment of the present invention.

FIG. 4 illustrates the execution of a wireless transaction in accordance with one embodiment of the present invention.

FIG. 5 illustrates the execution of a wireless transaction in accordance with one embodiment of the present invention

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention. Some portions of the detailed descriptions that follow are presented in terms of procedures, logic blocks, processing, and other symbolic representations of operations on data bits within a computer. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “setting,” “storing,” “scanning,” “receiving,” “sending,” “disregarding,” “entering,” “establishing,” “selecting,” “reading,” “validating,” “transmitting,” or the like, refer to the action and processes of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

This discussion of this embodiment of the present invention addresses the use of SmartCards in personal transactions, whether they are purchases, sales or other transactions involving validation of a user's identity as an authorized user. The present invention is discussed primarily in a context in which such transactions are conducted using wireless links.

SmartCards are a relatively recent addition to the world of information technology. As used herein, the term “SmartCard” refers to a class of electronic device that is normally the size of a conventional credit card, with an embedded electronic microchip in it which serves to process and store electronic data and is protected by advanced security features. The current standard to which such devices conform is ISO-7816.

The term SmartCard came about because of the form factor adopted in ISO-7816. The standard describes a credit-card sized device that is readable in a number of machines that are designed to physically read such cards. SmartCard technology is actually applicable to the computer chips which are imbedded in the cards and are the “smart” part of a SmartCard.

SmartCards are enabled to provide secure communication as to the identity of the user or to a monetary account balance that is maintained on the device itself. With sufficient security, aided by passwords and personal identification numbers (PIN), SmartCards are capable of behaving much like debit cards but without requiring the user to maintain an account in a financial institution. These types of SmartCards are sometimes called “e-cash” devices.

Initially, SmartCards were read by direct contact with card readers through contacts on the surface of the credit-card sized housing. However, they have evolved to incorporate non-contact communication with readers that are enabled with an infrared communication capability or one of many short-range RF standards, such as Bluetooth. Non-contact SmartCards are passed near an antenna to connect via a radio or infrared signal. Non-contact SmartCards are the same size as contact SmartCards but have both a microchip and an antenna embedded, not visible from the outside. This allows the SmartCard to communicate without physical contact. Contactless cards are an excellent solution for very fast transactions, as in mass-transit or toll collection services.

However, for other, higher value and thus more abuse-prone transactions, further authentication is required, commonly by entering a PIN on a keypad. For an even higher level of security, the large memory capacity of SmartCards can be used to store and compare biometric data. In using biometric data comparison, a user must pass a fingerprint, iris-scan or voice recognition test, where the data for verification is stored, and possibly encrypted, on the SmartCard.

This embodiment of the present invention presents a device that enables a completely contact free SmartCard transaction that benefits from the high security of biometric data comparison and verification yet allows for extremely convenient transactions. In the implementation of the embodiment envisioned, the SmartCard chip is contained in a wearable piece of functional jewelry, in this implementation, a wristwatch. This implementation, which could carry a possible trade name of “AuthentiSwatch” and will be referred to as such in much of this discussion, not only houses the SmartCard electronics and a transceiver device, it also provides a biometric data reader. Further discussion of some of the embodiments of the present invention can be aided by reference to the figures. Note that, while this discussion focuses on the implementation of this embodiment as a timepiece, many other implementations are envisioned, including wearable security badges, broaches and possibly tie pins, cufflinks, belt buckles or even writing pens or PDA styli.

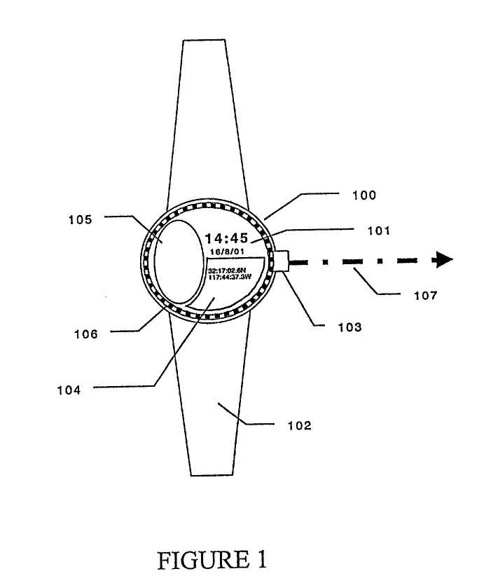

FIG. 1 illustrates a possible implementation of one embodiment of the present invention. In FIG. 1, “AuthentiSwatch” 100 is enabled with a time/date display 101, wrist band 102, adjustment knob 103 and display area 104 which is shown here with a latitude and longitude display from a GPS receiver. Also shown is area 105, which is enabled in this implementation as a fingerprint scanner, and bezel ring 106. Bezel ring 106 is shown only to illustrate the possibility of implementing an input device, perhaps to enable input of a PIN or to select a function from several. Item 107 is strictly for illustrative purposes. It is included to illustrate the ease of including infrared or RF communication in the watch body in order to implement non-contact communication.

Each of the items shown in FIG. 1 is only included for the purpose of illustration and example. None of the features illustrated should be construed as being an intrinsic part of this embodiment. Not shown in the illustration but understood to be fully implemented is the SmartCard ship at the heart of this embodiment.

The SmartCard chip would be, in this implementation, the residence of the biometric data employed with fingerprint scanner 105. In one envisioned enablement, the user would touch the proper finger to the fingerprint scanner and a proper authentication coupled with proximity and communication would result in a valid user verification.

In another envisioned embodiment, a sensor of the proper type could be implemented on the back of watch 100 that would could read body temperature or perhaps vein patterns on the wearer's wrist. In this fashion, yet another layer of biometric data security could be easily implemented in the same device. In one possible implementation of a wrist-worn embodiment, the device could be disabled until was properly worn by the correct user, even if the correct fingerprint were read. This additional security layer might provide yet another theft disincentive. Other, alternative, biometric input that could be implemented might be speech pattern recognition or perhaps an iris image.

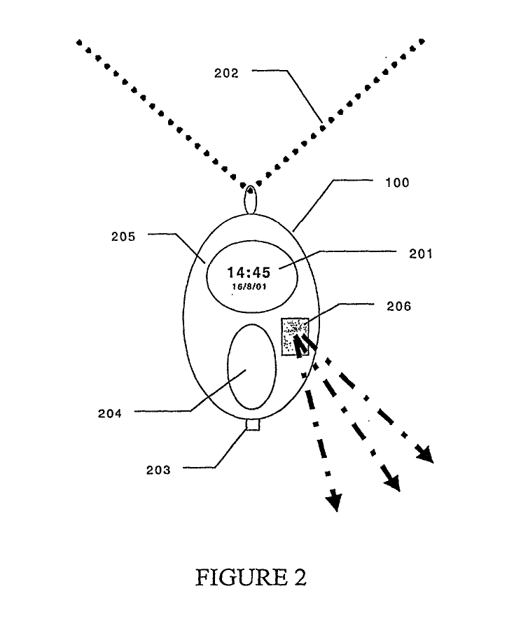

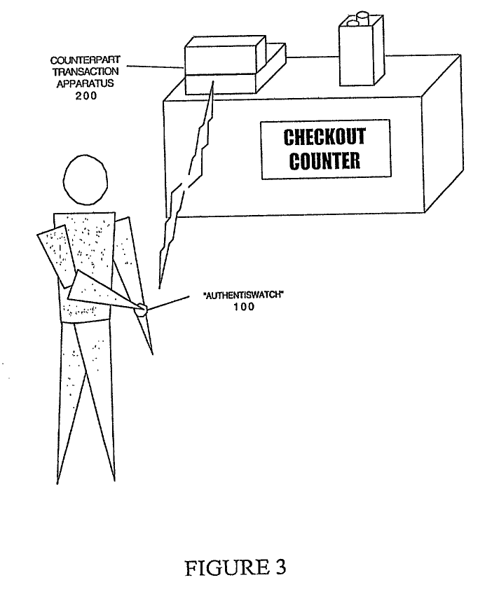

FIG. 2 illustrates another implementation of this embodiment. In this implementation, the functions and constructions are essentially the same as those in FIG. 1, with the exception of being enabled as a necklace timepiece. In FIG. 2, AuthentiSwatch 100 is suspended from necklace 202 but still incorporates the features appurtenant to this embodiment. Display 201 is enabled to show output data from the timepiece functions and the output of other included functions that may be enabled. Biometric data reader 204 could, again, be enabled as a fingerprint reader, a voice pattern reader, or any other type of biometric data reader enabled to read data suitable to identification of a user. Input device 206 might be implemented as a time adjustment device, a PIN entry device, or any other suitable input device. Communication device 206 is illustrated in FIG. 2 as an infrared device. Again, as in the implementation shown in FIG. 1, wireless communication could be enabled with any suitable wireless protocol, including RF, such as Bluetooth, or infrared. An advantage of the implementation of this embodiment as a necklace timepiece, as shown in FIG. 2, could be its utilization by only one of the user's hands.

Both the aforementioned implementations of this embodiment of the present invention provide opportunity for multiple levels of security. By requiring multiple levels, the secure limitation of the operation of the transactional capabilities this embodiment to a single, specific user could be virtually ironclad.

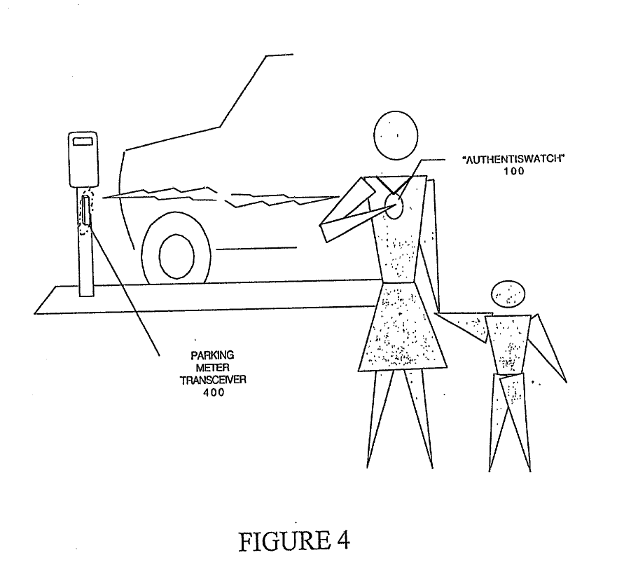

The range of applications of wireless transactions has no discernible limit. However, a few exemplary applications are outlined here in order to fully discuss this embodiment of the present invention. FIG. 3 illustrates the application of this embodiment of the present invention as an e-cash device. In FIG. 3, the user is paying for a store-bought purchase by the use of his e-cash SmartCard enabled AuthentiSwatch, 100. The counterpart electronic wireless transaction apparatus is vending device 300.

In the embodiment of the present invention shown in FIG. 4, the enabled transaction is car parking at a public parking meter. The parking meter is enabled by counterpart transaction device 400 to communicate wirelessly with AuthentiSwatch 100. Since it is envisioned that the wireless communication associated with this embodiment of the present invention is of a short range type, proximity to an enabled parking meter may serve in this scenario to select the desired transaction. Authentication would then be sent by the user's biometric data reader activation. It is possible that this activation could be initiated by the user's touching of a fingerprint reader.

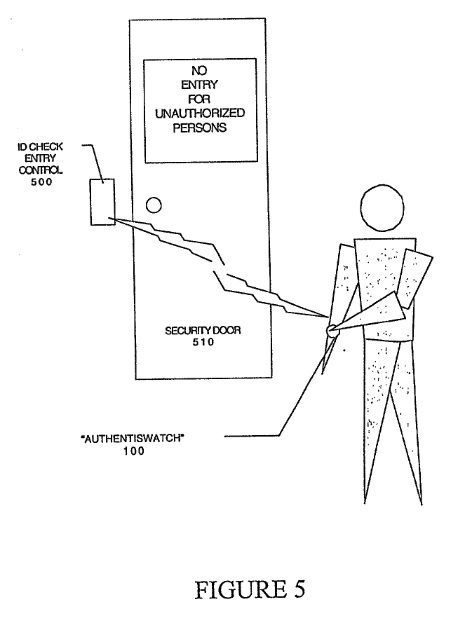

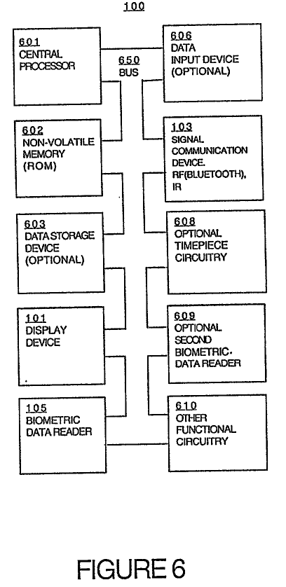

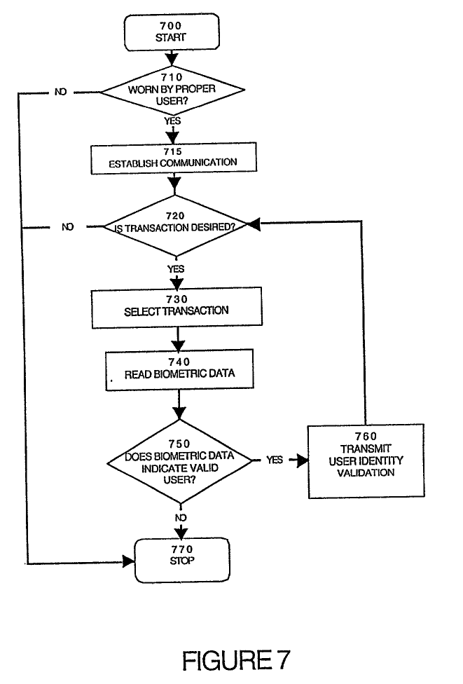

FIG. 5 illustrates another, slightly different type of transaction. Here, the user is assumably an authorized person seeking entry into a restricted entry area. By activating the biometric data reader on AuthentiSwatch 100, the user could transmit his or her identity to a counterpart device 500 adjacent to a secure door, 510. The security system associated with the secured area would then make a determination whether the validly identified user is or is not an authorized person.

Intimated in FIG. 5, though not explicitly illustrated, is the possible implementation of a proximity check that would be enabled by RF communications such as Bluetooth. In extremely high security facilities, it may be desirable to track the location of individuals within the facility. This may be particularly useful for emergency response personnel. If this implementation were equipped with an additional biometric reader that worked continually and passively, such as a temperature sensor, proximity communication establishment could be disabled if the wrong person were wearing the device. Such an implementation could provide an extraordinarily high degree of entry security. A form of non-contact, proximity, log on might be similarly enabled in a computer network environment.

FIG. 6 illustrates a block diagram of one implementation of the concepts presented in this embodiment of the present invention. Here “AuthentiSwatch” system 100 comprises a central processor 601 that communicates with other circuitry via bus 650. Also communicating via bus 650 are non-volatile ROM 602, optional data storage 603, display device 101, biometric data reader 105, optional data input device 606, signal communication device 103, timepiece circuitry 608 and an optional second biometric data reader 609. Other functional circuitry, indicated at 610, could also communicate via bus 650. In other possible implementations, much of the circuitry illustrated here may fully integrated to the point that some block illustrations in FIG. 6 may not apply. Such deviation from the illustrations here should not be construed as deviating from the concepts conveyed in the description of this embodiment of the present invention; the block illustrations are intended to illustrate functionality more than physical devices.

The many possible uses of other available functional circuitry at 610 may also be employed in some implementations. If a GPS receiver were incorporated, for example, its very accurate location information could be used as a backup to a proximity indication. In this manner, forgery of a device implemented as an embodiment of the present invention would be made much more difficult in that GPS location information would be made necessary to agree with proximity communications devices in order to authenticate a transaction.

FIG. 7 illustrates, in flowchart form, a transaction operation typical to possible implementations of this embodiment of the present invention. When in suitable proximity to a counterpart transaction device, and possibly only when worn by the authorized user, 710, communication would be established at 715, either automatically as would occur in a Bluetooth enabled embodiment, or by user input. If a transaction is desired, 720, a transaction selection would be made at 730 if such a selection were appropriate to the embodiment and the situation. To continue the transaction, the user's biometric data would be read at 740. If the biometric data indicated the proper user, 750, the identity validation would be transmitted at 760 and, if appropriate, another transaction would be awaited. If no valid identification is achieved, various implementation could possible transmit an alarm, halt any further transactions using the particular device, or simply stop, allowing the user to try again.

The illustrations provided in these Figures are not to be construed as limiting the application of any embodiment of the present invention to any particular type. The essence of this embodiment remains that of providing biometric data to validate a user's identity in order to authorize some sort of wireless transaction, no matter what the transaction may be. Though the illustrations presented herein have focused on implementation of this embodiment of the present invention as a wearable timepiece, it is conceivable that other implementations of the same concepts could be implemented as writing instruments, key chains or other items easily and normally carried by users.

The embodiments of the present invention discussed herein present various implementations of a user-wearable electronic wireless communication transaction device. These embodiments provide different ways to achieve an easy-to-incorporate form factor and convenience of operation in accomplishing transactions wirelessly and without physical contact between the user-wearable device and any applicable counterpart device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A user-wearable electronic wireless transaction apparatus, comprising:
a housing;
a wireless communication device fixedly mounted in said housing;
one or more electronic circuits fixedly mounted in said housing and communicatively coupled with said wireless communication device;
a power source electronically coupled with said electronic circuits;
a display device communicatively coupled with said electronic circuits; and, a biometric data reading device physically coupled with said housing and electronically coupled with said electronic circuits and with said communication device, wherein said biometric data reading device is enabled to provide user identity validation to said electronic circuits and said communication device.

2. A user-wearable electronic wireless transaction apparatus as described in claim 1, wherein said housing is in the form factor of a wristwatch.

3. A user-wearable electronic wireless transaction apparatus as described in claim 1, wherein said housing is in the form factor of a necklace.

4. A user-wearable electronic wireless transaction apparatus as described in claim 1, wherein said housing is in the form factor of a broach.

5. A user-wearable electronic wireless transaction apparatus as described in claim 1, wherein said housing is in the form factor of a security badge.

6. A user-wearable electronic wireless transaction apparatus as described in claim 1, wherein said wireless communication device is adapted to Bluetooth communication.

7. A user-wearable electronic wireless transaction apparatus as described in claim 1, wherein said wireless communication device is adapted to infrared communication.

8. A user-wearable electronic wireless transaction apparatus as described in claim 1, wherein one or more of said electronic circuits is a timepiece device.

9. A user-wearable electronic wireless transaction apparatus as described in claim 1, wherein said display device is adapted to display timepiece data.

10. A user-wearable electronic wireless transaction apparatus as described in claim 1, wherein said display device is adapted to display transaction data.

11. A user-wearable electronic wireless transaction apparatus as described in claim 1, wherein said biometric data reading device is adapted to read the user's fingerprint.

12. A user-wearable electronic wireless transaction apparatus as described in claim 1, wherein said biometric data reading device is adapted to read the user's computer-readable voice patterns.

13. A user-wearable electronic wireless transaction apparatus as described in claim 1, wherein said biometric data reading device is adapted to read the user's body electrical characteristics.

14. A user-wearable electronic wireless transaction apparatus as described in claim 1, wherein said biometric data reading device is adapted to read the user's body thermal characteristics.

15. A user-wearable electronic wireless transaction apparatus as described in claim 1, wherein said apparatus is enabled to provide user identity validation upon reading the authorized user's applicable biometric data.

16. A user-wearable electronic wireless transaction apparatus as described in claim 1, wherein said power source is a battery.

17. A user-wearable electronic wireless transaction apparatus as described in claim 1, wherein said power source is a solar cell.

18. A user-wearable electronic wireless transaction apparatus as described in claim 1, wherein said power source is charged by electromagnetic coupling from an external source.

19. A method for conducting wireless transactions, comprising:
establishing wireless communication with a transaction counterpart;
selecting a transaction;
reading biometric data of the user of said electronic wireless transaction apparatus;
validating said user's biometric data; and
transmitting a user identity validation upon successfully reading said user's biometric data.

20. The method described in claim 19, wherein said wireless communication is enabled with Bluetooth technology.

21. The method described in claim 19, wherein said wireless communication is enabled with infrared technology.

22. The method described in claim 19, wherein said transaction is a purchase.

23. The method described in claim 19, wherein said transaction a secure validated identification of said user.

24. The method described in claim 19, wherein said user's bio metric data is electronically stored in a user-wearable electronic wireless transaction apparatus.

25. The method described in claim 24, wherein said user's bio metric data is electronically stored in a secure apparatus located externally to said user-wearable electronic wireless transaction apparatus.

26. The method described in claim 24, wherein said wireless communication is disabled until said user's biometric data is validated.

27. A system for conducting electronic wireless transactions, comprising:
a user-wearable electronic wireless transaction apparatus;
a counterpart wireless transaction apparatus;
wireless communication between said electronic wireless transaction apparatus and said counterpart electronic wireless transaction apparatus; and,
a biometric data reading device communicatively coupled with said user-wearable electronic wireless transaction apparatus wherein said biometric data reading device is enabled to read a user's biometric data.

28. The system described in claim 27, wherein said user-wearable electronic wireless transaction device is enabled as a timepiece.

29. The system described in claim 27, wherein said wireless communication is enabled with Bluetooth technology.

30. The system described in claim 27, wherein said wireless communication is enabled with infrared technology.

31. The system described in claim 27, wherein said biometric data reading device is enabled as a fingerprint reading device.

32. The system described in claim 27, wherein said biometric data reading device is enabled to read said user's computer-identifiable voice characteristics.

33. The system described in claim 27, wherein said biometric data reading device is enabled to read said user's body thermal characteristics.

34. The system described in claim 27, wherein said biometric data reading device is enabled to read said user's body electrical characteristics.
